(19) United States
(12) Patent Application Publication
(10) Pub. No.: US 2026/0171311 A1
(43) Pub. Date: Jun. 18, 2026

(54) MULTILAYER ELECTRONIC COMPONENT

(71) Applicant: SAMSUNG ELECTRO-MECHANICS CO., LTD., Suwon-si (KR)

(72) Inventors: Jun Oh KIM, Suwon-si (KR); Seok Hyun YOON, Suwon-si (KR); Hyung Soon KWON, Suwon-si (KR); Geon Ju LEE, Suwon-si (KR); Han Seong JUNG, Suwon-si (KR); Min Young CHOI, Suwon-si (KR); Kyeong Su LEE, Suwon-si (KR); Chae Won KIM, Suwon-si (KR); Sang Il KIM, Suwon-si (KR)

(73) Assignee: SAMSUNG ELECTRO-MECHANICS CO., LTD., Suwon-si (KR)

(21) Appl. No.: 19/392,818

(22) Filed: Nov. 18, 2025

(30) Foreign Application Priority Data
Dec. 17, 2024 (KR) 10-2024-0188195

(51) Int. Cl. H01G 4/12; H01G 4/30

(52) U.S. Cl. CPC H01G 4/1209; H01G 4/30

(57) ABSTRACT

A multilayer electronic component according to an embodiment of the present disclosure may comprise a body including dielectric layers including Ba, Ti, and Ca and having a plurality of first and second dielectric grains and internal electrodes, and external electrodes disposed on the body. The plurality of first dielectric grains have a first core-shell structure including a first core and a first shell disposed on the first core, and the plurality of second dielectric grains have a second core-shell structure including a second core and a second shell disposed on the second core, the plurality of first dielectric grains may satisfy S1−C1≥0.7 at %, and the plurality of second dielectric grains may satisfy C2−S2<0.5 at %, where average contents of Ca included in the first and second cores are C1 and C2, respectively, and maximum contents of Ca included in the first and second shells are S1 and S2, respectively.

### CROSS-REFERENCE TO RELATED APPLICATION(S)

This application claims benefit of priority to Korean Patent Application No. 10-2024-0188195 filed on Dec. 17, 2024 in the Korean Intellectual Property Office, the disclosure of which is incorporated herein by reference in its entirety.

### TECHNICAL FIELD

The present disclosure relates to a multilayer electronic component.

A multilayer ceramic capacitor (MLCC), a multilayer electronic component, is a chip-type condenser, mounted on the printed circuit boards of various types of electronic products, such as image display devices including a liquid crystal display LCD and a plasma display panel PDP, computers, smartphones and mobile phones, and serves to charge or discharge electricity therein or therefrom.

In the case of MLCCs used in automotive electric components, demand for high-temperature warranty is increasing as a usage environment becomes harsher. However, BaTiO₃ (BT), which has a Curie temperature of approximately 120° C., has a problem in that the dielectric constant thereof rapidly decreases at higher temperatures.

(Ba₁₋ₓCaₓ)TiO₃ (BCT) may be used to improve the temperature coefficient of capacitance (TCC) of MLCC, but BCT has the problem of having a lower room temperature dielectric constant, as compared to BT.

Therefore, a method of forming a dielectric layer by mixing BT and BCT has been proposed, but additional research on a microstructure of dielectric grains configuring the dielectric layer is required to develop an MLCC with excellent electrostatic capacitance, temperature change characteristics, and lifespan reliability.

### RELATED ART DOCUMENT

### Patent Document

(Patent document 1) Korean Patent No. 10-2013-0062343

### SUMMARY

An aspect of the present disclosure may be to provide a highly reliable multilayer electronic component with excellent capacitance.

However, problems to be solved by the present disclosure are not limited to the above, and will be more easily understood in the process of describing specific embodiments of the present disclosure.

A multilayer electronic component according to some embodiments of the present disclosure may comprise a body including dielectric layers including Ba, Ti, and Ca and having a plurality of first and second dielectric grains and internal electrodes alternately disposed with the dielectric layer, and external electrodes disposed on the body, wherein the plurality of first dielectric grains may have a first core-shell structure including a first core and a first shell disposed on at least a portion of the first core, and the plurality of second dielectric grains may have a second core-shell structure including a second core and a second shell disposed on at least a portion of the second core, one or more of the plurality of first dielectric grains may satisfy S1−C1≥0.7 at %, and one or more of the plurality of second dielectric grains may satisfy C2−S2<0.5 at %, where average contents (at %) of Ca included in the first and second cores are C1 and C2, respectively, and maximum contents (at %) of Ca included in the first and second shells are S1 and S2, respectively.

### BRIEF DESCRIPTION OF DRAWINGS

The above and other aspects, features, and advantages of the present disclosure will be more clearly understood from the following detailed description, taken in conjunction with the accompanying drawings, in which:

FIG. 1 is a perspective view schematically illustrating a multilayer electronic component according to an embodiment of the present disclosure.

FIG. 2 is a cross-sectional view taken along line I-I′ of FIG. 1.

FIG. 3 is a cross-sectional view taken along line II-II′ of FIG. 1.

FIG. 4 is an enlarged view schematically illustrating region K1 of FIG. 2.

FIG. 5A is a graph illustrating a content of Y by location through a line profile for a first dielectric grain.

FIG. 5B is a graph illustrating a content of Ca by location through a line profile for a first dielectric grain.

FIG. 5C is a graph illustrating a content of Ca by location through a line profile for a second dielectric grain.

FIG. 6A is an image measuring a distribution of Ca inside a dielectric layer using transmission electron microscopy-energy dispersive X-ray analysis (TEM-EDS).

FIG. 6B is an image of line analysis of the first dielectric grain using TEM-EDS.

FIG. 6C is an image of line analysis of the second dielectric grain using TEM-EDS.

### DETAILED DESCRIPTION

Hereinafter, some embodiments of the present disclosure will be described with reference to specific embodiments and the accompanying drawings. However, embodiments of the present disclosure may be modified to have various other forms, and the scope of the present disclosure is not limited to the embodiments described below. Further, some embodiments of the present disclosure may be provided for a more complete description of the present disclosure to the ordinarily skilled artisan. Therefore, shapes and sizes of the elements in the drawings may be exaggerated for clarity of description, and the elements denoted by the same reference numerals in the drawings may be the same elements.

In the drawings, portions not related to the description will be omitted for clarification of the present disclosure, and a thickness may be enlarged to clearly illustrate layers and regions. The same reference numerals will be used to designate the same components in the same reference numerals. Further, throughout the specification, when an element is referred to as “comprising” or “including” an element, it means that the element may further include other elements as well, without departing from the other elements, unless specifically stated otherwise.

In the drawings, a first direction X may be defined as a thickness direction T, a second direction Y may be defined as a length direction L, and a third direction Z may be defined as a width direction W.

### Multilayer Electronic Component

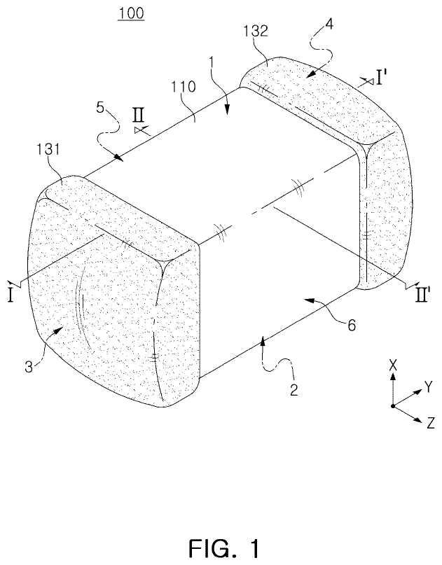

FIG. 1 is a perspective view schematically illustrating a multilayer electronic component according to an embodiment of the present disclosure.

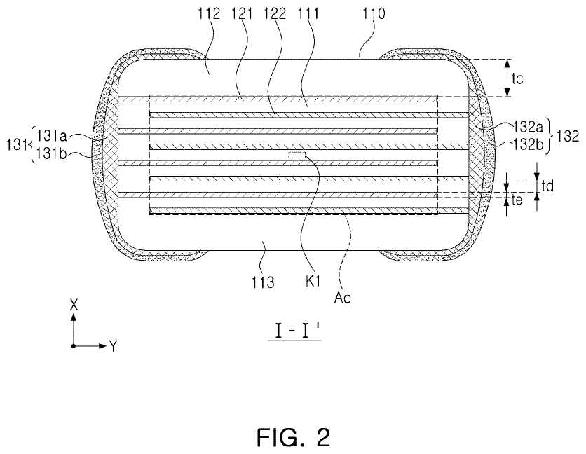

FIG. 2 is a cross-sectional view taken along line I-I′ of FIG. 1.

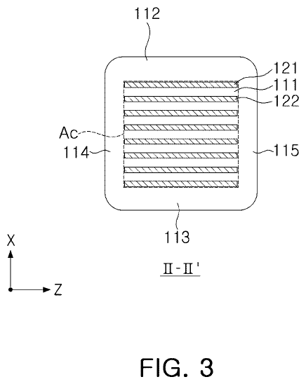

FIG. 3 is a cross-sectional view taken along line II-II′ of FIG. 1.

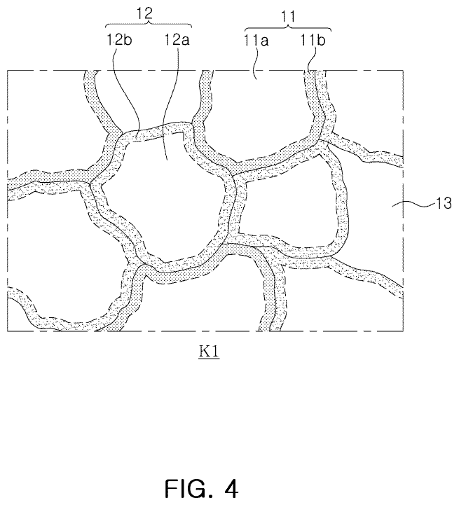

FIG. 4 is an enlarged view schematically illustrating region K1 of FIG. 2.

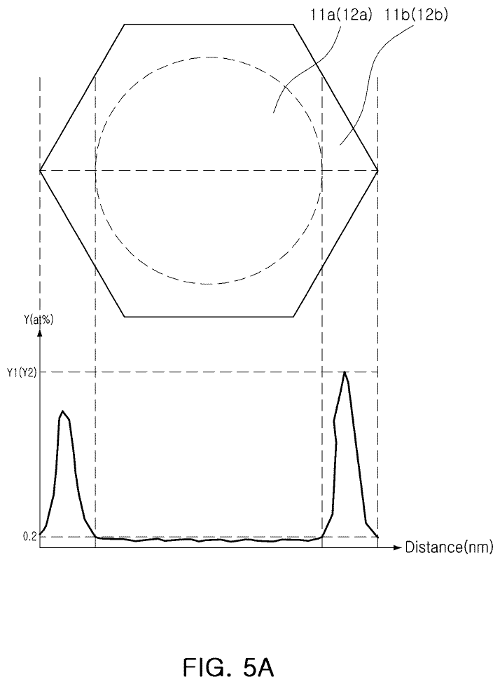

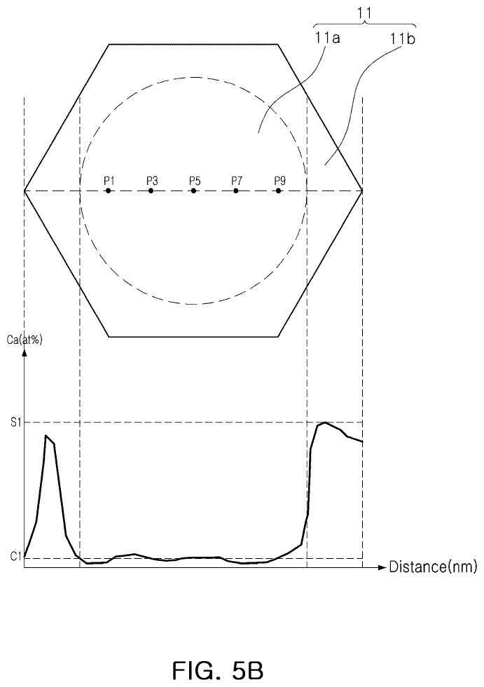

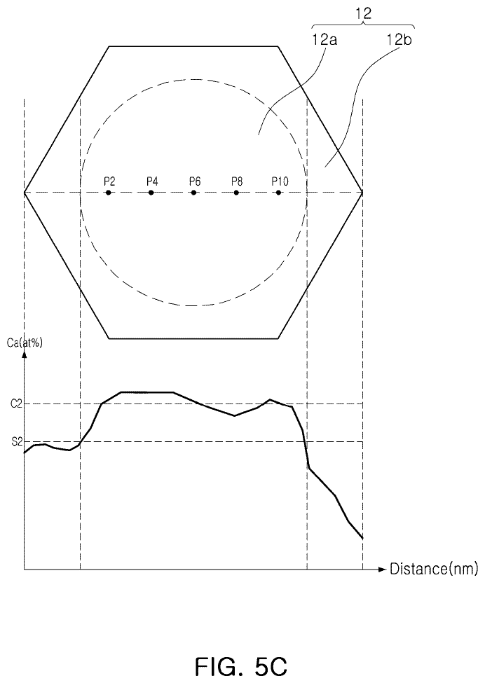

FIG. 5A is a graph illustrating a content of Y by location through a line profile for a first dielectric grain.

FIG. 5B is a graph illustrating a content of Ca by location through a line profile for a first dielectric grain.

FIG. 5C is a graph illustrating a content of Ca by location through a line profile for a second dielectric grain.

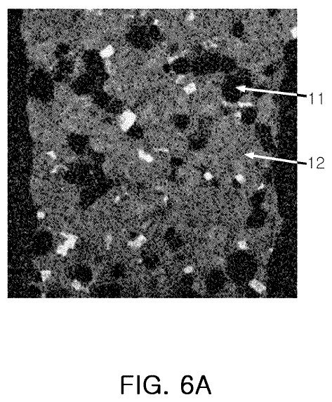

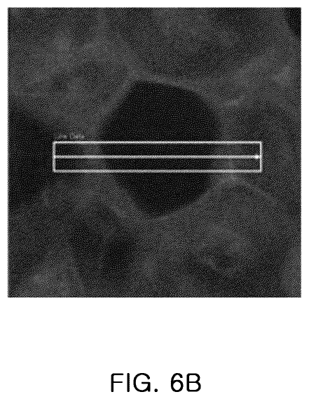

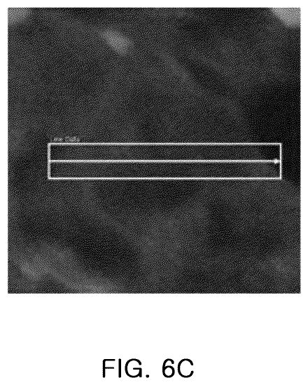

FIG. 6A is an image measuring a distribution of Ca inside a dielectric layer using transmission electron microscopy-energy dispersive X-ray analysis (TEM-EDS).

FIG. 6B is an image of line analysis of the first dielectric grain using TEM-EDS.

FIG. 6C is an image of line analysis of the second dielectric grain using TEM-EDS.

Hereinafter, a multilayer electronic component 100 according to an embodiment of the present disclosure will be described in detail with reference to FIGS. 1 to 6C. In addition, as an example of a multilayer electronic component, a multilayer ceramic capacitor is described, but the present disclosure is not limited thereto and may also be applied to various multilayer electronic components, such as inductors, piezoelectric elements, varistors, or thermistors.

A multilayer electronic component 100 according to some embodiments of the present disclosure may include a body 110 including a dielectric layer 111 and internal electrodes 121 and 122, and external electrodes 131 and 132 disposed on the body 110.

There is no particular limitation on the specific shape of the body 110, but as illustrated, the body 110 may have a hexahedral shape or a shape similar thereto. Due to shrinkage of ceramic powder particles included in the body 110 during a sintering process or due to the polishing process for the corner portions of the body 110, the body 110 may not have a hexahedral shape with entirely straight lines, but may have a substantially hexahedral shape.

The body 110 may have first and second surfaces 1 and 2 opposing each other in the first direction, third and fourth surfaces 3 and 4 connected to the first and second surfaces 1 and 2 and opposing each other in the second direction, and fifth and sixth surfaces 5 and 6 connected to the first to fourth surfaces 1, 2, 3, and 4 and opposing each other in the third direction.

The body 110 may include the dielectric layer 111 and internal electrodes 121 and 122 disposed alternately with a dielectric layer 111. A plurality of dielectric layers 111 are in a sintered state, such that boundaries between adjacent dielectric layers 111 may be integrated so as to be difficult to identify without using a scanning electron microscope (SEM).

The internal electrodes 121 and 122, for example, may include a first internal electrode 121 and a second internal electrode 122 that are alternately disposed in the first direction with the dielectric layer 111 interposed therebetween. The body 110 may include a capacitance formation portion Ac including the first internal electrode 121 and the second internal electrode 122 that are disposed to oppose each other with the dielectric layer 111 interposed therebetween to form capacitance.

The first internal electrode 121 may be spaced apart from the fourth surface 4 and may be connected to a first external electrode 131 on the third surface 3. The second internal electrode 122 may be spaced apart from the third surface 3 and may be connected to a second external electrode 132 on the fourth surface 4.

A conductive metal included in the internal electrode 121 and 122 may include one or more selected from the group consisting of Ni, Cu, Pd, Ag, Au, Pt, Sn, W, Ti, and alloys thereof, and more preferably, may include Ni, but the present disclosure is not limited thereto.

The body 110 may include cover portions 112 and 113 disposed on both surfaces of the capacitance formation portion Ac opposing each other in the first direction and margin portions 114 and 115 disposed on both surfaces of the capacitance formation portion Ac opposing in the third direction. The cover portions 112 and 113 and the margin portions 114 and 115 may have a similar configuration to that of the dielectric layer 111, except that they do not include the internal electrodes.

The external electrodes 131 and 132 may include the first external electrode 131 disposed on the third surface 3 and may extend onto portions of the first, second, fifth and sixth surfaces 1, 2, 5, and 6, and the second external electrode 132 disposed on the fourth surface 4 and may extend onto portions of the first, second, fifth and sixth surfaces 1, 2, 5, and 6.

Types or shapes of the external electrodes 131 and 132 may not be particularly limited, and may have a multilayer structure. For example, the external electrodes 131 and 132 may include base electrode layers 131a and 132a in contact with the internal electrodes 121 and 122 and plating layers 131b and 132b disposed on the base electrode layers 131a and 132a.

The base electrode layers 131a and 132a may be sintered electrode layers including metal and glass. The metal included in the base electrode layers 131a and 132a may include, for example, at least one selected from the group consisting of Cu, Ni, Pd, Pt, Au, Ag, Pb, and alloys thereof. The glass included in the base electrode layers 131a and 132a may include, for example, one or more selected from the group consisting of oxides of Ba, Ca, Zn, Al, B, and Si.

The base electrode layers 131a and 132a may be configured only with the sintered electrode layer, but the present disclosure is not limited thereto and the base electrode layers 131a and 132a may include a sintered electrode layer including metal and glass, and a resin electrode layer disposed on the sintered electrode layer and including metal particles and resin.

The metal particles included in the resin electrode layer may include one or more of spherical particles and flake-shaped particles. The metal particles included in the resin electrode layer may include, for example, at least one selected from the group consisting of Cu, Ni, Pd, Pt, Au, Ag, Pb, Sn and alloys thereof. The resin included in the resin electrode layer may include, for example, one or more of epoxy resin, acrylic resin, and ethyl cellulose.

The plated layers 131b and 132b may include, for example, Ni, Sn, Pd and/or alloys thereof, and may be formed of a plurality of layers. The plating layers 131b and 132b may be, for example, Ni plating layer or Sn plating layer, and may also be in the form in which the Ni plating layer and the Sn plating layer are formed sequentially thereon. The plating layers 131b and 132b may include a plurality of Ni plating layers and/or a plurality of Sn plating layers.

Although the drawing describes a structure in which a multilayer electronic component 100 has two external electrodes 131 and 132, it may not be limited thereto, and the number or shape of the external electrodes 131 and 132 may be changed depending on the shape of the internal electrodes 121 and 122 or other purposes.

The dielectric layer 111 may include, for example, a perovskite-type compound represented by a general formula ABO₃. The A may include one or more of Ba and Ca, and the B may include one or more of Ti and Zr. The dielectric layer 111 may include the perovskite-type compound as a main component.

The dielectric layer 111 may include Ba and Ti. The dielectric layer 111 may include, for example, a barium titanate (BaTiO₃)-based compound as a main component, and the barium titanate-based compound may include one or more selected from the group consisting of BaTiO₃, (Ba₁₋ₓCaₓ)TiO₃ (0<x<1), Ba(Ti_{1-y}Ca_{y})O₃ (0<y<1), (Ba₁₋ₓCaₓ) (Ti_{1-y}Zr_{y})O₃ (0<x<1, 0<y<1) and Ba(Ti_{1-y}Zr_{y})O₃ (0<y<1).

The dielectric layer 111 may include Ca. Ca included in the dielectric layer 111 may be derived from a main component such as (Ba₁₋ₓCaₓ)TiO₃ (BCT), or may be derived from a subcomponent, CaCO₃. Ca may effectively substitute for Ba-sites because it has the same electron valence as Ba, configuring a lattice structure of BT, but has a slightly smaller ionic radius that that of Ba. In this case, lattice shrinkage may be induced without defect chemical bonding, and temperature coefficient of capacitance (TCC) characteristics of the dielectric may be improved by increasing a phase-transition temperature due to lattice distortion.

In the present disclosure, the term “main component” may refer to a component occupying a relatively higher weight ratio or atomic number ratio compared to other components, and may refer to a component exceeding 50 wt % based on the total weight of the dielectric composition or the entire dielectric layer, a component exceeding 50 at % based on the number of atoms, or a component exceeding 50 mol % based on the number of moles. In the present disclosure, “subcomponent” may refer to a component occupying a relatively small ratio compared to the main component.

The dielectric layer 111 may include a plurality of first dielectric grains 11 and a plurality of second dielectric grains 12. The plurality of first dielectric grains 11 and the plurality of second dielectric grains 12 may have a core-shell structure. Specifically, the plurality of first dielectric grains 11 may have a first core-shell structure including a first core 11a and a first shell 11b disposed on at least a portion of the first core 11a. The plurality of second dielectric grains 12 may have a second core-shell structure including a second core 12a and a second shell 12b disposed on at least a portion of the second core 12a.

The core-shell structure may be formed by adding a rare earth element to the perovskite-type compound. Specifically, the rare earth element may form shells 11b and 12b by substituting an A site or B site of the perovskite-type compound. These shells 11b and 12b may act as a barrier to a flow of oxygen vacancies, thereby suppressing leakage current.

The shells 11b and 12b may be disposed to cover the entire surface of cores 11a and 12a, but the present disclosure is not limited thereto, and the shells 11b and 12b may not cover a portion of surfaces of the cores 11a and 12a. For example, the shells 11b and 12b may be disposed to cover more than 90% of a total surface area of the cores 11a and 12a, and in this case, a reliability improvement effect of the present disclosure may become more remarkable.

Meanwhile, the dielectric layer 111 may include one or more third dielectric grains 13 that may not have the core-shell structure.

Considering the capacitance and reliability of multilayer electronic components, a dielectric layer of mixed grain type configured of BT grains and BCT grains has been proposed in the past. The BT grains may act to improve a room temperature capacitance of the multilayer electronic component, and the BCT grains may act to improve the TCC of the multilayer electronic component. However, when a microstructure of the dielectric grains is not properly controlled, it may be difficult to optimize the capacitance, TCC, and MTTF of the multilayer electronic component simply by having two types of dielectric grains.

Accordingly, in a multilayer electronic component 100 according to some embodiments of the present disclosure, one or more of the plurality of first dielectric grains 11 may satisfy S1−C1≥0.7 at %, and one or more of the plurality of second dielectric grains 12 may satisfy C2−S2<0.5 at %, where an average content (at %) of Ca included in the first and second cores 11a and 12a are C1 and C2, respectively, and a maximum content (at %) of Ca included in the first and second shells 11b and 12b are S1 and S2, respectively. Among the plurality of first dielectric grains 11, a grain satisfying S1−C1≥0.7 at % may be defined as a first specific grain, and among the plurality of second dielectric grains 12, a grain satisfying C2−S2<0.5 at % may be defined as a second specific grain. By including the first and second specific grains satisfying the above numerical ranges, the capacitance, TCC, and MTTF of the multilayer electronic component 100 may all be effectively improved.

When the S1−C1 is less than 0.7 at %, there may be a concern that the TCC of the multilayer electronic component 100 may deteriorate, and when the C2−S2 is 0.5 at % or more, there may be a concern that the capacitance and/or MTTF of the multilayer electronic component 100 may deteriorate.

The upper limit of S1−C1 is not particularly limited, but one or more of the plurality of first dielectric grains 11 may satisfy 0.7 at %<S1−C1 3.0 at %. That is, the first specific grain may have S1−C1 of 3.0 at % or less. When S1−C1 exceeds 3.0 at %, there is a concern that a dielectric constant of the dielectric layer 111 may decrease. The lower limit of C2−S2 is not particularly limited, and the second specific grains may have C2−S2 of 0 at % or more.

The C1 and S1 may be measured, for example, from a line profile measured by a transmission electron microscopy-energy dispersive spectroscopy (TEM-EDS) analysis of the first dielectric grain 11. Referring to FIG. 5B, the C1 may be measured by measuring the Ca content at a plurality of equally spaced points disposed in the first core 11a, for example, at five points P1, P3, P5, P7 and P9, and then calculating the average value. The S1 may refer to the maximum content of Ca included in the first shell 11b, measured by the line profile.

The C2 and S2 may be measured, for example, from a line profile analyzed by TEM-EDS of the second dielectric grain 12. Referring to FIG. 5C, the C2 may be measured by measuring Ca content at a plurality of equally spaced points disposed on the second core 12a, for example, at five points P2, P4, P6, P8 and P10, and then taking the average value. The S2 may refer to a maximum content of Ca included in the second shell 12b measured by the line profile.

Meanwhile, a boundary between the cores 11a and 12a and the shells 11b and 12b may be defined through a content of a rare earth element (e.g., Y) included as a subcomponent. For example, the plurality of first and second dielectric grains 11 and 12 may include Y, a rare earth element, and the first and second cores 11a and 12a may be defined as a region where a content of Y is less than 0.2 at %, and the first and second shells 11b and 12b may be defined as a region where a content of Y is 0.2 at % or more.

The Y content may be measured, for example, from a line profile of the dielectric grains 11 and 12 analyzed by TEM-EDS. Referring to FIG. 5A, in the line profile, a boundary between the cores 11a and 12a, and the shells 11b and 12b may be defined as a point where the Y content is 0.2 at %. The line profile may be obtained by analyzing the cross-sections in the first and second direction polished to a central portion of the multilayer electronic component 100 in the third direction using TEM-EDS, and may be obtained, for example, from a central region of the body 110 in the first and second direction (region K1 in FIG. 2).

Referring to FIG. 5A, in some embodiment, a maximum content Y1 of Y included in the first shell 11b may be 1.0 at % or more, and a maximum content Y2 of Y included in the second shell 12b may be 1.0 at % or more. Accordingly, the reliability of the multilayer electronic component 100 may be improved by having the first and second dielectric grains 11 and 12 with a robust core-shell structure. The upper limits of the Y1 and Y2 are not particularly limited, but may be, for example, 5.0 at % or less. When the Y1 and Y2 exceed 5.0 at %, there is a concern that a dielectric constant of the dielectric layer 111 may be reduced.

Referring to FIG. 6A, the first dielectric grains 11 and the second dielectric grains 12 may be distinguished by color and/or brightness within an image in which Ca distribution was measured using TEM-EDS. However, the first dielectric grains 11 and the second dielectric grains 12 may be more accurately distinguished from the Ca contents of the cores 11a and 12a and shells 11b and 12b measured by the line profile. Specifically, among dielectric grains of the core-shell structure, a dielectric grain in which an average content of Ca contained in the core is less than a maximum content of Ca contained in the shell may be defined as the first dielectric grains 11, and among dielectric grains of the core-shell structure, a dielectric grain in which an average content of Ca contained in the core is greater than or equal to a maximum content of Ca contained in the shell may be defined as the second dielectric grains 12. That is, the plurality of first dielectric grains 11 may satisfy C1<S1, and the plurality of second dielectric grains 12 may satisfy C2 S2.

In addition, the first dielectric grains 11 and the second dielectric grains 12 may also be distinguished from the Ca content of the cores 11a and 12a measured by the line profile. Specifically, among dielectric grains having the core-shell structure, dielectric grains having an average content of Ca contained in the core of less than 0.8 at % may be defined as the first dielectric grains 11, and among dielectric grains having the core-shell structure, dielectric grains having an average content of Ca contained in the core of 0.8 at % or more may be defined as the second dielectric grains 12. That is, the plurality of first dielectric grains 11 may satisfy C1<0.8 at %, and the plurality of second dielectric grains 12 may satisfy C2≥0.8 at %. The upper limit of the C2 is not particularly limited, but may be, for example, 5.0 at % or less.

In some embodiments, the number ratio of grains satisfying S1−C1≥0.7 at % among the plurality of first dielectric grains 11 in the dielectric layer may be 70% or more. That is, the number ratio of the first specific grains among the plurality of first dielectric grains 11 in the dielectric layer may be 70% or more. Therefore, the improvement in capacitance, TCC, and MTTF according to the present disclosure, may be further enhanced.

In some embodiments, the number ratio of grains satisfying C2−S2<0.5 at % among the plurality of second dielectric grains 12 may be 70% or more. That is, the number ratio of the second specific grains among the plurality of second dielectric grains 12 may be 70% or more. Therefore, the improvement in capacitance, TCC, and MTTF according to the present disclosure, may be further enhanced.

The dielectric layer 111 may include the plurality of first dielectric grains 11 and the plurality of second dielectric grains 12, and the number ratio of the plurality of first dielectric grains 11 and the plurality of second dielectric grains 12 in the dielectric layer 111 is not particularly limited. However, in a cross-section of the dielectric layer 111, a ratio of the area occupied by the plurality of first dielectric grains 11 may be, for example, 10% or more and 50% or less. Therefore, the improvement in capacitance, TCC, and MTTF of the multilayer electronic component 100, may be further effectively improved.

The number ratio of the specific grains may be determined by specifying a certain region in an image analyzed by an analysis devices such as TEM-EDS, or the like of an arbitrary cross-section of the dielectric layer 111, and it may be calculated from the total number of dielectric grains 11 and 12 existing within the region and the number of the specific grains. The ratio of an area occupied by the plurality of first dielectric grains 11 may be calculated by specifying a certain region in an image analyzed by an analysis device such as TEM-EDS of an arbitrary cross-section of the dielectric layer 111, and it may be calculated from the total area of the corresponding region and the area occupied by a plurality of first dielectric grains 11.

The total number of dielectric grains 11 and 12 extracted from the certain region may be, for example, 10 or more, but the present disclosure is not limited thereto.

In some embodiments, one or more of the plurality of first dielectric grains 11 may have a maximum diameter of 100 nm or more and 450 nm or less, and one or more of the plurality of second dielectric grains 12 may have a maximum diameter of 100 nm or more and 450 nm or less. The maximum diameter of the dielectric grains 11 and 12 may refer to a maximum length of a straight line connecting one grain boundary to another grain boundary of the dielectric grains 11 and 12. When the maximum diameter satisfies the numerical range, the dielectric characteristics of the dielectric grains 11 and 12 may be excellent, and sintering and grain-growth control may be easy.

In some embodiments, one or more of the plurality of first dielectric grains 11 may have a maximum diameter of the first core 11a of 70 nm or more and 400 nm or less, and one or more of the plurality of second dielectric grains 12 may have a maximum diameter of the second core 12a of 70 nm or more and 400 nm or less. The maximum diameter of the cores 11a and 12a may refer to a maximum value of a length corresponding to the cores 11a and 12a among lengths of a straight line connecting one grain boundary of the dielectric grains 11 and 12 to another grain boundary. When the maximum diameter of the cores 11a and 12a is less than 70 nm, it may be difficult to achieve the targeted dielectric characteristics, and when it exceeds 400 nm, there is a concern that the reliability of the multilayer electronic component 100 may be reduced.

In addition, an average size of the plurality of first dielectric grains 11 may be 100 nm or more and 450 nm or less, and an average size of the plurality of second dielectric grains 12 may be 100 nm or more and 450 nm or less. An average size of the plurality of first cores 11a may be 70 nm or more and 400 nm or less, and an average size of the plurality of second cores 12a may be 70 nm or more and 400 nm or less.

The average size of the dielectric grains 11 and 12 may refer an average value of the maximum diameters of the plurality of dielectric grains 11 and 12 existing in a region of 3 μm×4 μm when an arbitrary region of the cross-section of the dielectric layer 111, for example, 3 μm×4 μm (width×length), is observed by using SEM or TEM. The average size of the cores 11a and 12a may refer to an average value of the maximum diameters of the plurality of cores 11a and 12a existing in the 3 μm×4 μm region. The 3 μm×4 μm region may be specified in the cross sections in the first and second direction polished to the center of the multilayer electronic component 100 in the third direction, and may be specified in the central region of the body 110 in the first and second direction.

Hereinafter, subcomponents that may be included in the dielectric layer 111 will be described. The subcomponents are explained based on amounts of mol of elements, and may be calculated by converting them into an input content of oxide or carbonate of an additive before sintering. The content of elements before and after sintering may not have a large error value unless there are special circumstances, and types and contents of elements included in the dielectric layer 111 may be measured by using various measuring methods such as SEM-EDS, TEM-EDS, and STEM-EDS after sintering.

As an example of a more specific method for measuring the content of each element included in the dielectric layer 111, components inside the dielectric grains in the central portion of the body 110 may be analyzed by using TEM-EDS or STEM-EDS. First, a thinned analysis sample is prepared by using a focused ion beam (FIB) device in a region including the dielectric layer 111 among the cross-section of the body 110 after sintering is completed. Then, a damaged layer on a surface of the thinned sample is removed using Ar ion milling, and qualitative/quantitative analysis are performed by mapping each component in an image obtained by using (S)TEM-EDS. In this case, the qualitative/quantitative analysis graph of each component may be expressed by converting it into the mass fraction (wt %), atomic percentage (at %), or mol fraction (mol %) of each element.

In another method, the body 110 is crushed, the internal electrodes 121 and 122 are removed, and the dielectric layer 111 portion is then selected, the components of the selected dielectric layer 111 may be analyzed using devices such as an inductively coupled plasma optical emission spectrometer (ICP-OES), an inductively coupled plasma mass spectrometer (ICP-MS), or the like.

### 1) A First Subcomponent

The dielectric layer 111 may further include rare earth elements other than Y. For example, the dielectric layer 111 may further include a first subcomponent including one or more selected from the group consisting of Dy, Tb, Sc, La, Nd, Eu, Gd, Ho, Er, Yb, and Lu. The first subcomponent may play a role in improving the reliability of the multilayer electronic component 100.

A content of the first subcomponent included in the dielectric layer 111 may be 2.5 mol or more and 10.0 mol or less per 100 mol of Ti. Therefore, the room temperature dielectric constant and/or insulation resistance characteristics may be improved.

### 2) A Second Subcomponent

The dielectric layer 111 may include one or more of a fixed-valence acceptor element and a variable-valence acceptor element. In this case, the fixed-valence acceptor element may include Mg and/or Zr, and the variable-valence acceptor element may include one or more selected from the group consisting of Mn, V, Cr, Fe, Ni, Co, Cu, and Zn. That is, the dielectric layer 111 may further include a second subcomponent including one or more selected from the group consisting of Mg, Zr, Mn, V, Cr, Fe, Ni, Co, and Zn.

The variable-valence acceptor element and the fixed-valence acceptor element may act to reduce an electron concentration and may act to lower a sintering temperature and improving a high-temperature withstand voltage characteristics of the multilayer electronic component. A content of the second subcomponent included in the dielectric layer 111 may be, for example, 0.01 mol or more and 8.0 mol or less per 100 mol of Ti.

### 3) A Third Subcomponent

The dielectric layer 111 may further include a third component including one or more of Si and Al. The third subcomponent may act to improve the dielectric constant and Dc-bias characteristics by improving a sintering density.

A content of the third subcomponent included in the dielectric layer 111 may be, for example, 1.0 mol or more and 5.0 mol or less per 100 mol of Ti.

In order to appropriately control a microstructure of the dielectric layer 111, the dielectric layer 111 may further include at least one selected from the group consisting Y, Dy, Mg, Zr, Mn, V, Si, and Al among the aforementioned subcomponents.

In the line profile analyzed through TEM-EDS of the first dielectric grain 11, an average content of Dy included in the first core 11a may be less than a maximum content D1 of Dy included in the first shell 11b. An average content of Zr included in the first core 11a may be less than a maximum content Z1 of Zr included in the first shell 11b.

One or more of the plurality of first dielectric grains 11 may satisfy, for example, Y1>S1, Y1>D1, and/or Y1>Z1. One or more of the plurality of first dielectric grains 11 may satisfy, for example, S1>D1 and/or S1>Z1. In an embodiment, one or more of the plurality of first dielectric grains 11 may satisfy Y1>S1>D1 and Y1>S1>Z1. Therefore, the reliability of the multilayer electronic component 100 may be improved by the first dielectric grains 11 having a robust core-shell structure.

Similarly, in the line profile analysis of the second dielectric grain 12 through TEM-EDS, an average content of Dy included in the second core 12a may be less than a maximum content D2 of Dy included in the second shell 12b. An average content of Zr included in the second core 12a may be less than a maximum content Z2 of Zr included in the second shell 12b.

One or more of the plurality of second dielectric grains 12 may satisfy, for example, Y2>D2 and/or Y2>Z2. One or more of the plurality of second dielectric grains 12 may satisfy, for example, S2>D2 and/or S2>Z2. One or more of the plurality of second dielectric grains 12 may satisfy, for example, C2>Y2, C2>D2, and/or C2>Z2. In some embodiments, one or more of the plurality of second dielectric grains 12 may satisfy C2>Y2>D2 and C2>Y2>Z2. In some embodiments, one or more of the plurality of second dielectric grains 12 may satisfy S2>D2, S2>Z2, Y2>D2 and Y2>Z2. Therefore, the reliability of the multilayer electronic component 100 may be improved by the second dielectric grains 12 having a robust core-shell structure.

Meanwhile, the average or maximum contents of Dy and Zr included in the cores 11a and 12a, and shells 11b and 12b may be measured by the same method as C1, S1, C2 and S2 described above.

A size of the multilayer electronic component 100 is not particularly limited, but a maximum length of the multilayer electronic component 100 in the second direction may be 0.1 mm to 6.0 mm, a maximum width of the multilayer electronic component 100 in the third direction may be 0.1 mm to 5.0 mm, and a maximum thickness of the multilayer electronic component 100 in the first direction may be 0.05 mm to 3.5 mm.

An average thickness td of the dielectric layer 111 may be, for example, 0.1 μm to 20 μm, 0.1 μm to 10 μm, 0.1 μm to 5 μm, 0.1 μm to 2 μm, or 0.1 μm to 0.4 μm. An average thickness te of the internal electrode 121 and 122 may be, for example, 0.1 μm to 3.0 μm, 0.1 μm to 1.0 μm, or 0.1 μm to 0.4 μm.

The average thickness td of the dielectric layer 111 and an average thickness te of the internal electrodes 121 and 122 may refer to the average thicknesses of the dielectric layer 111 and the internal electrodes 121 and 122 in the first direction, respectively. The average thickness td of the dielectric layer 111 and the average thickness te of the internal electrodes 121 and 122 may be measured by scanning cross sections of the body 110 in the first and second directions with a scanning electron microscope (SEM) at 10,000× magnification. More specifically, the average thickness td of the dielectric layer 111 may be measured by calculating the average after measuring the thickness at a plurality of points of one dielectric layer 111, for example, at 5 points equally spaced apart from each other in the second direction, and then taking the average value. Additionally, the average thickness te of the internal electrodes 121 and 122 may be measured by calculating the average after measuring the thickness at a plurality of points of one internal electrode 121 and 122, for example, at 5 points equally spaced apart from each other in the second direction. The 5 points equally spaced apart from each other may be designated in the capacitance formation portion Ac. Meanwhile, when the average value measurements are performed for each of 10 dielectric layers 111 and 10 internal electrodes 121 and 122, and then the average values are calculated, the average thickness td of the dielectric layer 111 and the average thickness te of the internal electrodes 121 and 122 may be further generalized.

An average thickness tc of cover portions 112 and 113 may be, for example, 150 μm or less, 100 μm or less, 30 μm or less, or 20 μm or less. The average thickness of the cover portions 112 and 113 may be, for example, 5 μm or more, 10 μm or more, or 30 μm or more. An average thickness of the margin portions 114 and 115 may be, for example, 150 μm or less, 100 μm or less, 20 μm or less, or 15 μm or less.

In this case, the average thickness tc of the cover portions 112 and 113 may refer to an average thickness of each of a first cover portion 112 and a second cover portion 113, and the average thickness of the margin portions 114 and 115 may refer to an average thickness of each of a first margin portion 114 and a second margin portion 115.

The average thickness tc of the cover portions 112 and 113 may refer to an average thickness of the cover portions 112 and 113 in the first direction, and may be an average value of thickness in the first direction measured at 5 points equally spaced apart from each other in a cross-section of the body 110 in the first and second directions. The average thickness wm of the margin portions 114 and 115 may refer to an average thickness of the margin portions 114 and 115 in the third direction, and may be an average value of a thickness in the third direction measured at 5 points equally spaced apart from each other in a cross-section of the body 110 in the first and third directions.

Hereinafter, an example of a method for forming a multilayer electronic component 100 will be described. However, the method of manufacturing the multilayer electronic component 100 is not limited thereto.

First of all, ceramic powder for forming a dielectric layer 111 are prepared. The main component powder may include one or more selected from the group consisting of BaTiO₃, (Ba₁₋ₓCaₓ)TiO₃ (0<x<1), Ba(Ti_{1-y}Ca_{y})O₃ (0<y<1), (Ba₁₋ₓCaₓ) (Ti_{1-y}Zr_{y})O₃ (0<x<1, 0<y<1) and Ba(Ti_{1-y}Zr_{y})O₃ (0<y<1). The main component powder may contain 10 to 40 weight portions of the BT powder based on 100 weight portions of a total of a BT powder and a BCT powder.

The first to third subcomponent powders may be added to the main component powder. The subcomponent powder may include, for example, one or more selected from the group consisting of CaCO₃ powder, Y₂O₃ powder, Dy₂O₃ powder, MgO powder, ZrO₂ powder, MnO₂ powder, V₂O₅ powder, SiO₂, and Al₂O₃ powder.

Next, the main component powder with the subcomponent powder added is mixed with an organic solvent such as ethanol and a binder such as polyvinyl butyral, and then ball milled to prepare a dielectric composition, and the dielectric composition is applied and dried on a carrier film to prepare a ceramic green sheet.

Next, conductive paste for an internal electrode containing metal powder, binder, organic solvent, or the like is printed onto the ceramic green sheet with a predetermined thickness using a screen printing method or a gravure printing method, thereby forming an internal electrode pattern.

Thereafter, the sheet for forming a ceramic green sheet having the internal electrode pattern printed thereon is peeled off from the carrier film, and then a predetermined number of ceramic green sheet having the internal electrode pattern printed thereon are laminated and pressed to form a ceramic laminate. On the upper and lower portions of the ceramic laminate, a ceramic green sheet without an internal electrode pattern, may be laminated in a predetermined amount of layers to form the cover portion 112 and 113 after sintering. Thereafter, the ceramic laminate is cut to have a predetermined size of a chip and then, the cut chips may be sintered at a temperature of 1000° C. or higher and 1400° C. or lower for 1 to 3 hours in a 1.0% H₂/99.0% N₂ to 3.5% H₂/96.5% N₂ (H₂O/H₂/N₂ atmosphere) to form the body 110.

Next, the external electrodes 131 and 132 may be formed. For example, when the base electrode layers 131a and 132a includes a sintered electrode layer, the body 110 may be dipped in an external electrode conductive paste containing metal powder, glass frit, binder, and organic solvent, followed by sintering the conductive paste at a temperature of 500° C. to 900° C. to form a sintered electrode layer.

For example, when the base electrode layers 131a and 132a include a resin electrode layer, the body may be dipped in a conductive resin composition including metal powder, resin, binder, and organic solvent, followed by curing heat treatment at a temperature of 250° C. to 550° C. to form the resin electrode layer.

In addition, an electrolytic plating method and/or an electroless plating method may be additionally performed to form a plated layers 131b and 132b on the base electrode layers 131a and 132a.

### EXAMPLE

Hereinafter, the present disclosure will be described in more detail through examples. However, the following examples are intended to help in a specific understanding of the present disclosure, and the scope of the present disclosure is not limited by the following examples.

### Examples 1 to 7

A main component powder was prepared by mixing BT powder and BCT powder having a composition of (Ba₁₋ₓCaₓ)TiO₃ (0<x<1) in a weight % ratio of 10:90 to 40:60. Thereafter, CaCO₃ powder, Y₂O₃ powder, Dy₂O₃ powder, MgO powder, ZrO₂ powder, MnO₂ powder, V₂O₅ powder, SiO₂, and Al₂O₃ powder were mixed with the main component powder at a predetermined ratio, and an organic solvent and a binder were added, and then ball milled to form a dielectric composition. Meanwhile, CaCO₃ powder was added in an amount of 1 to 10 weight portions per 100 weight portions of the main component powder.

In addition, a conductive paste for the internal electrode was formed by mixing Ni powder and an organic solvent. After forming a ceramic laminate using the dielectric composition and the conductive paste for internal electrodes, the ceramic laminate was cut to a predetermined size to form a laminated chip. Next, the laminated chips were sintered to form a body. Thereafter, a sample chip was prepared by sequentially forming a sintered electrode layer containing Cu, a Ni plating layer, and a Sn plating layer on a surface of the body. The sample chip was manufactured in size 1005 (length: approximately 1.0 mm, width: approximately 0.5 mm, thickness: approximately 0.5 mm).

### Comparative Example (Ref)

Instead of using a mixed powder of BT powder and BCT powder as the main component powder, only BT powder was used. Additionally, CaCO₃ powder was not added. Other than that, it was manufactured in the same method as Example 1.

### Measurement of a Ca Content

Among the cross sections in the first and second direction polished to the center of the sample chip in the third direction, the central regions in the first and second directions are analyzed by TEM-EDS.

Thereafter, a line profile analysis is performed on the first and second dielectric grains. The line profile was performed in a range from one grain boundary to another grain boundary of the dielectric grains, as shown in FIGS. 6B and 6C.

Meanwhile, in the line profile illustrating an Y content by location within the dielectric grains (e.g., FIG. 5A), the region where the Y content is less than 0.2 at % was defined as a core, and the region where the Y content is 0.2 at % or more was defined as a shell. Thereafter, C1, S1, C2, and S2 were measured through a line profile illustrating a Ca content at each location within the dielectric grains.

Based on the line profile results analyzing a Ca distribution included in the first dielectric grains, the Ca content was measured at five equally spaced points disposed in a first core, and an average value was designated as C1, and a maximum Ca content included in a first shell was designated as S1.

Similarly, based on the line profile results analyzing a Ca distribution included in the second dielectric grains, the Ca content was measured at five equally spaced points disposed in a second core, and an average value was designated as C2, and a maximum Ca content included in a second shell was designated as S2.

Based on the C1, S1, C2 and S2, the S1−C1 and C2-S2 values were calculated and listed in Table 1 below.

### Capacitance Evaluation

Capacitance was measured by using an LCR meter at 1 kHz and 1 Vrms 24 hours after heat-treating a sample chip at 150° C. When the capacitance of a comparative example is 2, a relative values of the capacitance of the examples are listed in Table 1 below, and when the relative value of the capacitance is 1 or more, it is judged as good (OK), and when it is less than 1, it is judged as bad (NG).

### TCC Evaluation

TCC was measured at 150° C. When TCC of the comparative example is 0.5, a relative values of TCC of examples are listed in Table 1 below, and when the relative value of the TCC is 1 or greater, it is judged as good (OK), and when it is less than 1, it is judged as bad (NG).

### MTTF Evaluation

The mean time to failure (MTTF) was measured as an average time in which the insulation resistance of all sample chips fell to 100 kΩ or less, when a temperature of 150° C. and a voltage three times the rated voltage were applied to 80 sample chips for each sample number. When MTTF of the comparative example is 1.5, the relative values of MTTF of the examples are listed in Table 1 below, and when the relative value of MTTF is 1 or greater, it is determined as good (OK), and when it is less than 1, it is determined as bad (NG).

TABLE 1

| | C1 | S1 | C2 | S2 | S1 − C1 | C2 − S2 | | | | |
|---|---|---|---|---|---|---|---|---|---|---|
| Examples | (at %) | (at %) | (at %) | (at %) | (at %) | (at %) | Capacitance | TCC | MTTF | Judgement |
| Ref | 0 | 0 | 0 | 0 | 0 | 0 | 2 | 0.5 | 1.5 | NG |
| 1 | 0 | 0.4 | 1.6 | 1.1 | 0.4 | 0.5 | 1.31 | 0.91 | 1.11 | NG |
| 2 | 0 | 0.7 | 1.4 | 1.2 | 0.7 | 0.2 | 1.12 | 1.05 | 1.23 | OK |
| 3 | 0.1 | 1.0 | 3.5 | 2.2 | 0.9 | 1.3 | 0.84 | 1.11 | 0.91 | NG |
| 4 | 0.1 | 1.3 | 1.2 | 1.1 | 1.2 | 0.1 | 1.08 | 1.06 | 1.04 | OK |
| 5 | 0 | 1.7 | 2.0 | 1.4 | 1.7 | 0.6 | 0.94 | 1.09 | 0.94 | NG |
| 6 | 0.1 | 1.9 | 1.8 | 1.5 | 1.8 | 0.3 | 1.02 | 1.03 | 1.10 | OK |
| 7 | 0.1 | 1.1 | 1.3 | 1.3 | 1 | 0 | 1.05 | 1.03 | 1.08 | OK |

Example 1 illustrates that the TCC characteristics of the sample chip are deteriorated because S1−C1 is less than 0.7 at %. Additionally, it may be confirmed that the capacitance and MTTF characteristics of the sample chip are deteriorated in Examples 3 and 5 because C2−S2 exceeds 0.5 at %. However, it may be confirmed that the sample chips of Examples 2, 4, 6 and 7 have excellent capacitance, TCC and MTTF characteristics by satisfying S1−C1≥0.7 at % and C2−S2<0.5 at %.

The present disclosure is not limit the above-described embodiments and the accompanying drawings but is defined by the appended claims. Therefore, those of ordinary skill in the art may make various replacements, modifications, or changes without departing from the scope of the present disclosure defined by the appended claims, and these replacements, modifications, or changes should be construed as being included in the scope of the present disclosure.

In addition, the expression ‘an example embodiment’ does not mean the same embodiment, and is provided to emphasize and explain different unique characteristics. However, the embodiments presented above do not preclude being implemented in combination with the features of another embodiment. For example, although items described in a specific embodiment are not described in another embodiment, the items may be understood as a description related to another embodiment unless a description opposite or contradictory to the items is in another embodiment.

In the present disclosure, the term “connected” includes not only direct connection but also indirect connection through an adhesive layer or the like. Additionally, the term electrically connected includes both physically connected and not physically connected. The terms “first,” “second,” and the like may be used to distinguish one element from another, and may not limit a sequence and/or an importance, or others, in relation to the elements. In some cases, a first element may be referred to as a second element, and similarly, a second element may be referred to as a first element without departing from the scope of right of the example embodiments.

As one of the various effects of the present disclosure, a multilayer electronic component with excellent reliability can be provided.

While example embodiments have been shown and described above, it will be apparent to those skilled in the art that modifications and variations could be made without departing from the scope of the present invention as defined by the appended claims.

What is claimed is:

1. A multilayer electronic component comprising:
a body including: a dielectric layer including Ba, Ti and Ca and having a plurality of first and second dielectric grains; and internal electrodes alternately disposed with the dielectric layer; and
an external electrode disposed on the body,
wherein the plurality of first dielectric grains have a first core-shell structure including a first core and a first shell disposed on at least a portion of the first core,
wherein the plurality of second dielectric grains have a second core-shell structure including a second core and a second shell disposed on at least a portion of the second core,
wherein one or more of the plurality of first dielectric grains satisfy S1−C1≥0.7 at %, and one or more of the plurality of second dielectric grains satisfies C2−S2<0.5 at %,
where average contents (at %) of Ca included in the first and second cores are C1 and C2, respectively, and maximum contents (at %) of Ca included in the first and second shells are S1 and S2, respectively.

2. The multilayer electronic component of claim 1, wherein one or more of the plurality of first dielectric grains satisfy 0.7 at %≤S1−C1≤3.0 at %.

3. The multilayer electronic component of claim 1, wherein the plurality of first and second dielectric grains include Y,
wherein the first and second cores are regions in which a content of Y is less than 0.2 at %, and the first and second shells are regions in which a content of Y is 0.2 at % or more.

4. The multilayer electronic component of claim 3, wherein a maximum content of Y included in the first shell is 1.0 at % or more,
wherein a maximum content of Y included in the second shell is 1.0 at % or more.

5. The multilayer electronic component of claim 1, wherein the plurality of first dielectric grains satisfy C1<S1,
wherein the plurality of second dielectric grains satisfy C2≥S2.

6. The multilayer electronic component of claim 1, wherein the plurality of first dielectric grains satisfy C1<0.8 at %,
wherein the plurality of second dielectric grains satisfy C2≥0.8 at %.

7. The multilayer electronic component of claim 5, wherein a ratio of the number of grains satisfying S1−C1≥0.7 at % among the plurality of first dielectric grains is 70% or more.

8. The multilayer electronic component of claim 5, wherein a ratio of the number of grains satisfying C2−S2<0.5 at % among the plurality of second dielectric grains is 70% or more.

9. The multilayer electronic component of claim 5, where in a cross-section of the dielectric layer, a ratio of an area occupied by the plurality of first dielectric grains is 10% or more and 50% or less.

10. The multilayer electronic component of claim 1, wherein one or more of the plurality of first dielectric grains have a maximum diameter of 100 nm or more and 450 nm or less,
wherein one or more of the plurality of second dielectric grains have a maximum diameter of 100 nm or more and 450 nm or less.

11. The multilayer electronic component of claim 1, wherein one or more of the plurality of first dielectric grains have a maximum diameter of the first core of 70 nm or more and 400 nm or less, and
wherein one or more of the plurality of second dielectric grains have a maximum diameter of the second core of 70 nm or more and 400 nm or less.

12. The multilayer electronic component of claim 1, wherein the dielectric layer further includes one or more selected from the group consisting of Dy, Tb, Sc, La, Nd, Eu, Gd, Ho, Er, Yb and Lu.

13. The multilayer electronic component of claim 1, wherein the dielectric layer further includes one or more selected from the group consisting of Mg, Zr, Mn, V, Cr, Fe, Ni, Co and Zn.

14. The multilayer electronic component of claim 1, wherein the dielectric layer further includes Si and/or Al.

15. The multilayer electronic component of claim 1, wherein the dielectric layer further includes Y, Dy, Mg, Zr, Mn, V, Si and Al.
